(19) United States
(12) Patent Application Publication
(10) Pub. No.: US 2010/0211639 A1
(43) Pub. Date: Aug. 19, 2010

(54) APPARATUS AND METHOD FOR SERVING ANNULAR MESSAGES TO LOCAL BROWSERS

(75) Inventor: FLEMING SHI, Cupertino, CA (US)

Correspondence Address: PATENTRY, P.O. BOX 151616, SAN RAFAEL, CA, 94915-1616, US

(73) Assignee: BARRACUDA NETWORKS, INC, CAMPBELL, CA (US)

(21) Appl. No.: 12/371,102

(22) Filed: Feb. 13, 2009

(51) Int. Cl. G06F 15/16; G06F 17/00

(52) U.S. Cl. 709/206; 715/234

(57) ABSTRACT

A system to enable a local area network operator to optimize bandwidth by controlling annular display surrounding sourced content. An apparatus for storing content sponsor messages locally to a user's network. A method for selecting among locally served messages, images, and applications to support delivery of content provider's intellectual property. In short, optimizing and tuning the delivery of the message annulus surrounding the “news hole” of a webpage.

### BACKGROUND

In traditional print and broadcast journalism, the editorial management places news and features into a “news hole” measured in column inches in newspapers and measured in minutes in radio/television. In the present patent application we define all the area of a webpage which surrounds a “news hole” as the annulus. In classical geometry, an annulus is the area between two concentric circles. By extension an annulus can surround a rectangular hole. For the purpose of disclosing the present claimed invention succinctly, a banner advertisement is an exemplary part of a webpage annulus. Content sponsors are defined to include advertisers. An annular server is defined as an apparatus which serves files to a browser to provision elements of a webpage annulus such as a banner advertisement paid for by a content sponsor. Referring now to FIG. 2, a data flow diagram illustrates a conventional website request from a user to a sponsored content provider. A user at a user browser apparatus 210 requests a service through a LAN/WAN gateway 202 from a content provider 350. The content provider website server 350 delivers the content along with links to a sponsor message aggregator server 320. The user browser apparatus 210 displays the content in the “news hole” and around it the advertisements provided by a plurality of content sponsors such as the non-limiting exemplary content sponsor A and content sponsor B. Generally, impression compensation is paid by a content sponsor to the sponsor message aggregator and thence to the content provider for delivery.

Referring to FIG. 3 is a dataflow diagram of a conventional click-through by a user on an advertisement provisioned alongside content from a content provider. If user exhibits an interest in one of the sponsor messages by clicking on the message, a further request is made using the hypertext transfer protocol (http) and tracked to the website server of a selected content sponsor such as non-limiting exemplary content sponsor A 324. Generally, click-through compensation is paid by the selected content sponsor to both the content provider and the sponsor message aggregator.

One problem with this conventional mechanism is that because revenue is tracked by browser requests, the same content, often bandwidth intensive high resolution images, audio, and video, is repeatedly transferred through the LAN/WAN gateway creating a heavy burden on both the user's infrastructure and the Internet Service Provider. It is common that clicking-through to an advertiser's website programmatically leads to a series of additional queries or searches to find a local retailer, distributor, or service provider such as selecting from a series of menus for global, then national, then state, and finally city lists of franchisees or entering of zip codes to display maps of the locations within a 5, 10, 25 mile radius of the zip code, or displaying an alphabetized list of partner companies with further links to their respective websites thereby instigating even further http request traffic.

Thus it can be appreciated that what is needed is a way for content sponsors to communicate to users more efficiently and a way for users to consume less bandwidth.

### SUMMARY OF THE INVENTION

The present invention provides for local provisioning of annular messages with respect to user's location. A webpage transmitted by a content provider in reply to a user is analyzed for its payload, traditionally called the “news hole” in print journalism, and the annular messaging that, conceptually, surrounds the “news hole”.

Localized control of annular messages allows for more efficient use of bandwidth by the service providers. A link to a content sponsor message aggregator's server on the Internet such as an advertisement on a webpage, is identified and replaced with a link to an object stored in the local area network of the user.

Local provisioning of annular messages allows small business owners to efficiently communicate to their target market. Local provisioning of annular messages allows more precise targeting of messages to selected demographies according to the local area networks on which the annular server is installed. Locally metered provisioning of annular imagery allows least disruption of employees or higher user focus on task by replacing some messaging by blank space or non-commercial messages or images according to a setting by a local administrator. An annular server receives a web page request from a local user and proxies it to an external server and receives the requested web page. The annular server determines which is the content portion of the requested web page and which is the annular messaging, i.e. that which is not in the “news hole”. The annular server replaces links, in an example text enclosed between the href html tags, with links to files on local servers. In an embodiment a commercial message is replaced by decorative patterns, solid colors, or white space. In an embodiment a commercial message is replaced by some personal content. In an embodiment, a commercial message is replaced by the same commercial message but served from a local server. In an embodiment, a commercial message is replaced by a similar commercial message from a related business partner. It is known that a circuit can be implemented by a processor under software control.

### BRIEF DESCRIPTION OF THE DRAWINGS

FIG. 1 is a block diagram of a non-limiting exemplary computer system adapted to an embodiment of the present invention.

FIG. 2 and 3 are data flow diagrams of conventional website delivery of content and annular messaging.

FIG. 4-6 are data flow diagrams of embodiments of the invention.

FIG. 7 represents preferred embodiment block diagram of the invention.

FIG. 8 illustrates a news hole and annular messages on a webpage.

### DETAILED DISCLOSURE OF EMBODIMENTS OF THE INVENTION

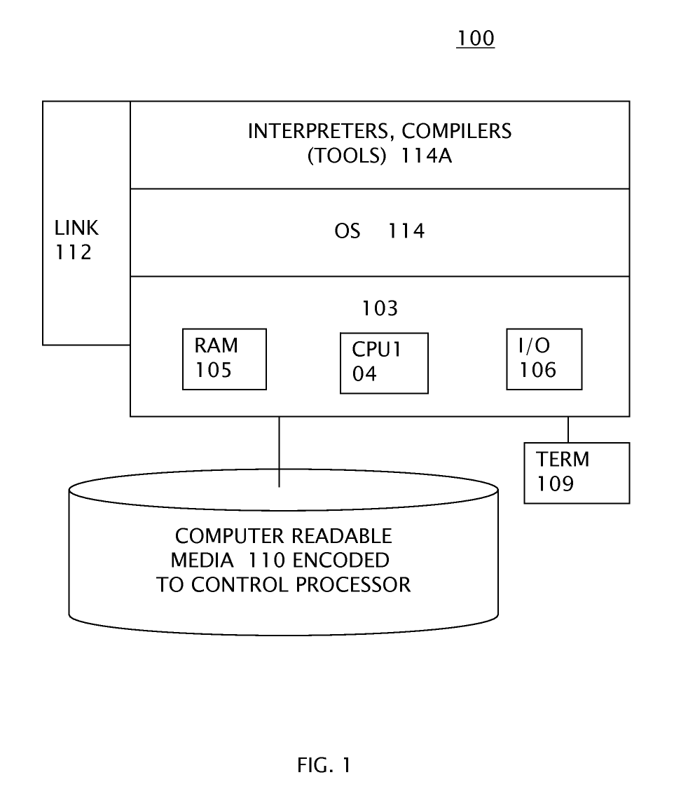

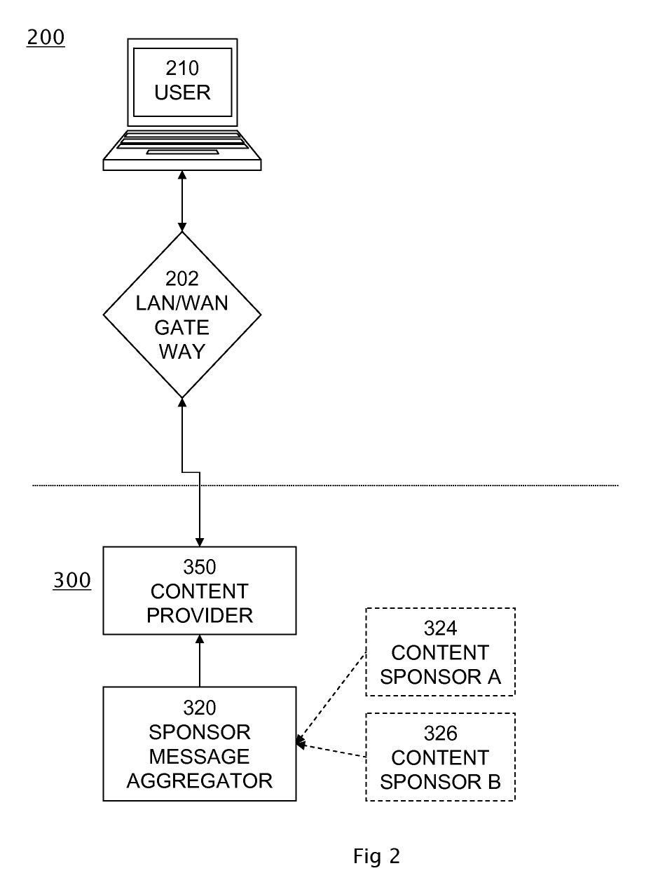

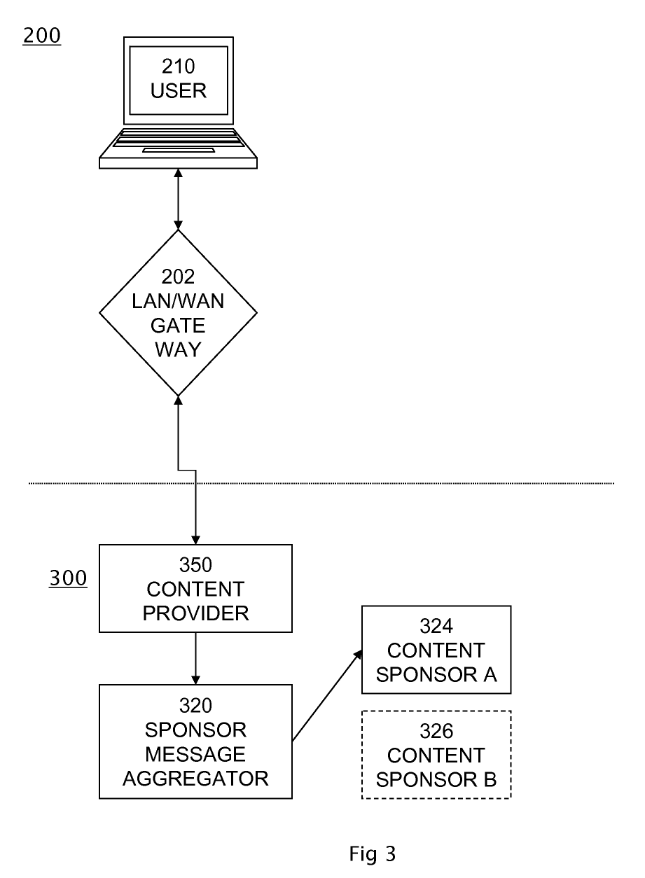

FIG. 1 shows a block diagram of a typical computing system 100 where the preferred embodiment of this invention can be practiced. The computer system 100 includes a computer platform having a hardware unit 103, that implements the methods disclosed below. The hardware unit 103 typically includes one or more central processing units (CPUs) 104, a memory 105 that may include a random access memory (RAM), and an input/output (I/O) interface 106. Microinstruction code 107, may also be included on the platform 102. Various peripheral components may be connected to the computer platform 102. Typically provided peripheral components include an external data storage device (e.g. tape or disk) 110 where the data used by the preferred embodiment is stored. A link 112 may also be included to connect the system 100 to one or more other similar computer systems. The link 112 may also provide access to the global Internet. An operating system (OS) 114 coordinates the operation of the various components of the computer system 100, and is also responsible for managing various objects and files, and for recording certain information regarding same. Lying above the OS 114 is a software tools layer 114A containing, for example, compilers, interpreters and other software tools. The interpreters, compilers and other tools in the layer 114A run above the operating system and enable the execution of programs using the methods known to the art.

One suitable and non-limiting example of computer system 100 is the Barracuda WebFilter. An example of a suitable CPU is a Pentium.™. III processor (trademark of the Intel Corporation); examples of an operating systems is GNU/Linux; examples of an interpreter and a compiler are a Perl interpreter and a C++ compiler. Those skilled in the art will realize that one could substitute other examples of computing systems, processors, operating systems and tools for those mentioned above. As such, the teachings of this invention are not to be construed to be limited in any way to the specific architecture and components depicted in FIG. 1.

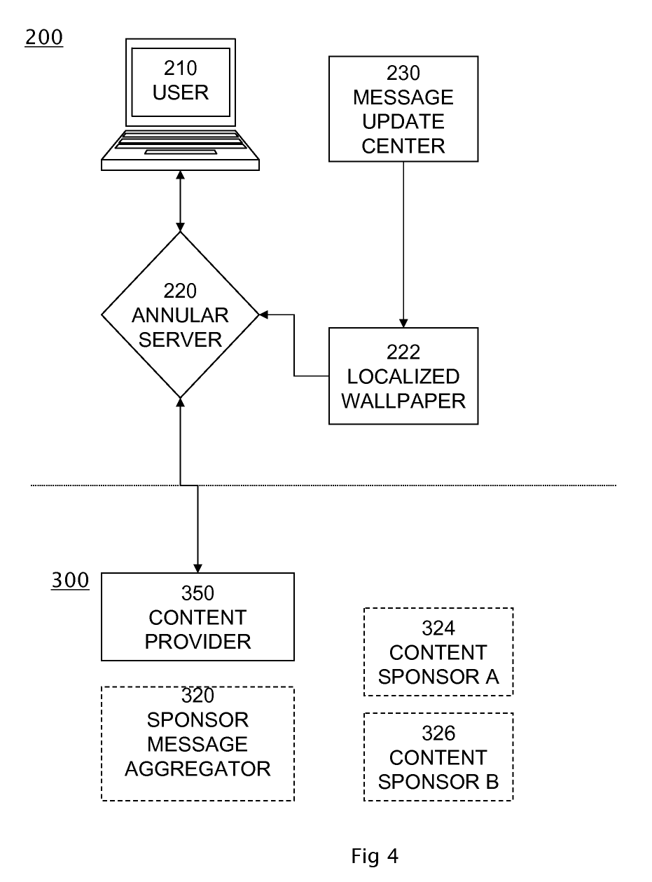

Referring to FIG. 4 a user browser apparatus 210 transmits an request, in a non-limiting example a hypertext transfer protocol request, through an annular server of the present invention 220 which contacts and receives a webpage from the content provider website server 350. However, the links to sponsor messages embedded in the webpage are replaced with selected links to files on a localized wallpaper store 222. By transmitting the modified webpage to the user browser apparatus 210, the annular server reduces bandwidth consumption across the LAN/WAN boundary.

In an embodiment the localized wallpaper is selected according to the wishes of the local network owner to reduce interruptions from the user on-task focus. In an embodiment the localized wallpaper displays live feeds of children, elders, doorways, goldfish or panoramas. In an embodiment the localized wallpaper displays non-distracting solid colors, motivational thoughts of the day, or inspirational portraits of executive management of the enterprise.

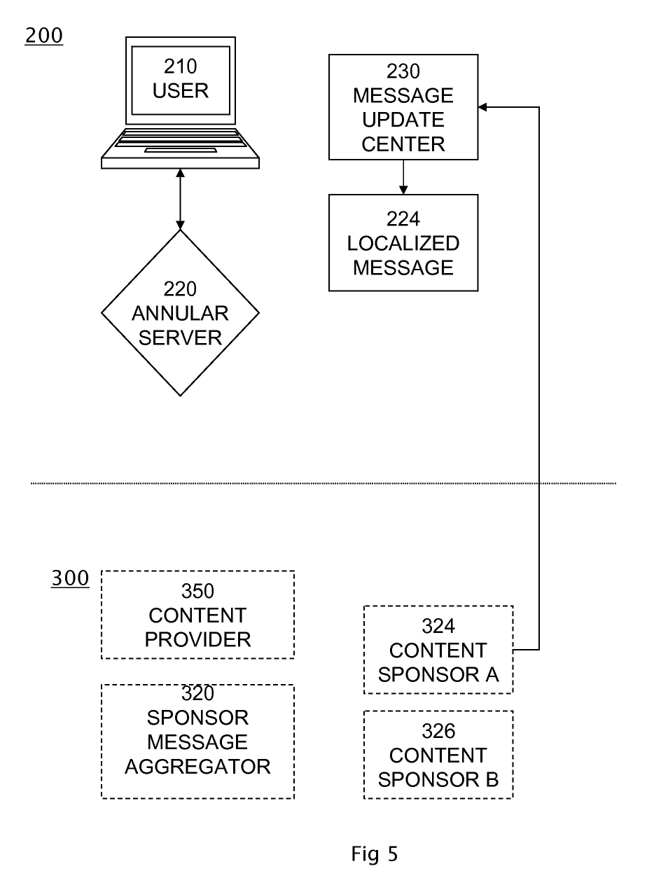

Referring now to FIG. 5, a content sponsor may transmit a localized message to a message update center apparatus 230 and which is stored into a certain localized message store 224. In an embodiment the localized message is the same as the world wide message provided by content sponsor A 224 at an advantageous rate. In an embodiment the localized message is tailored to the reseller, distributor, franchisee, retailer, dealer or location of the content sponsor nearest to the annular server.

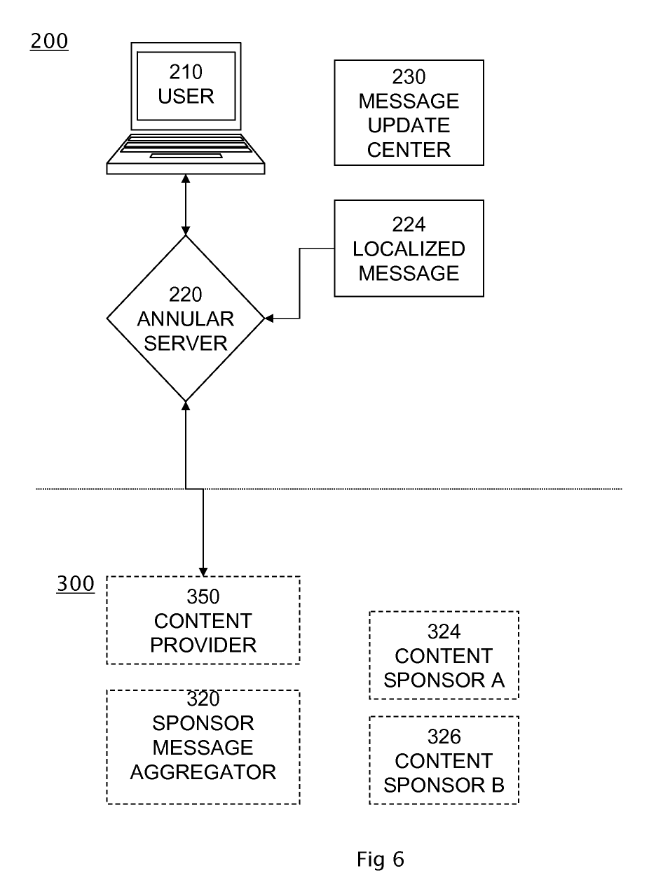

Referring to FIG. 6 a user browser apparatus 210 requests a webpage through an annular server of the present invention 220 which contacts and receives a webpage in reply from the content provider website server 350. However, links in the webpage to sponsor message servers are replaced with appropriate links to a localized message store 224. The annular server transmits the modified page to the user browser apparatus 210.

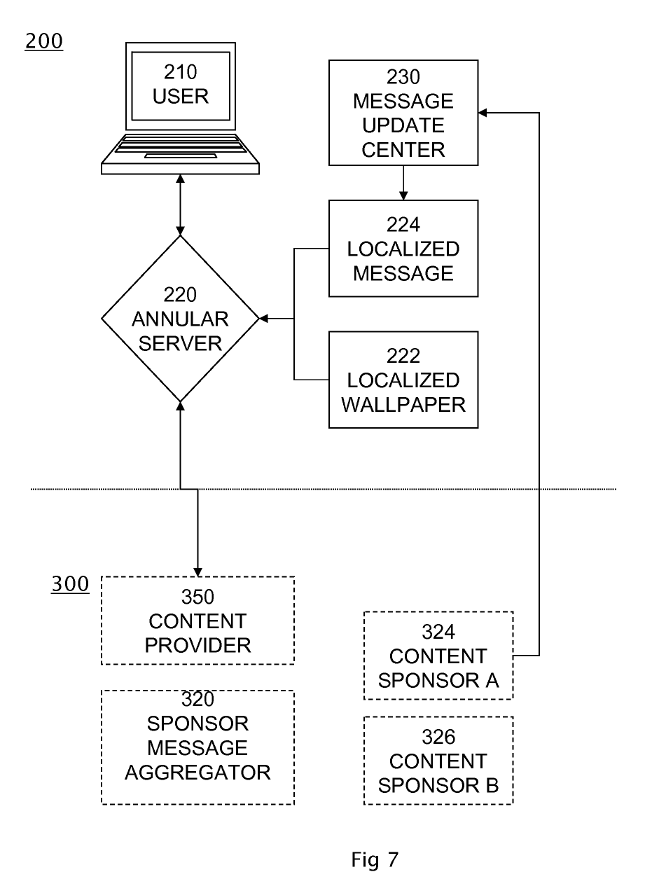

FIG. 7 is a block diagram of the present invention comprising an annular server 220 coupled to a user browser apparatus 210, and coupled through a public network to a content provider website server 350. The annular server is coupled to a localized wallpaper server 222, the annular server is coupled to a localized message server 224. The localized message server is coupled through a public network to a message update center 230 which serves a plurality of annular message servers. The message update center 230 receives localized messages from a plurality of content sponsors and distributes the localized messages to a plurality of localized message stores attached to a plurality of annular servers.

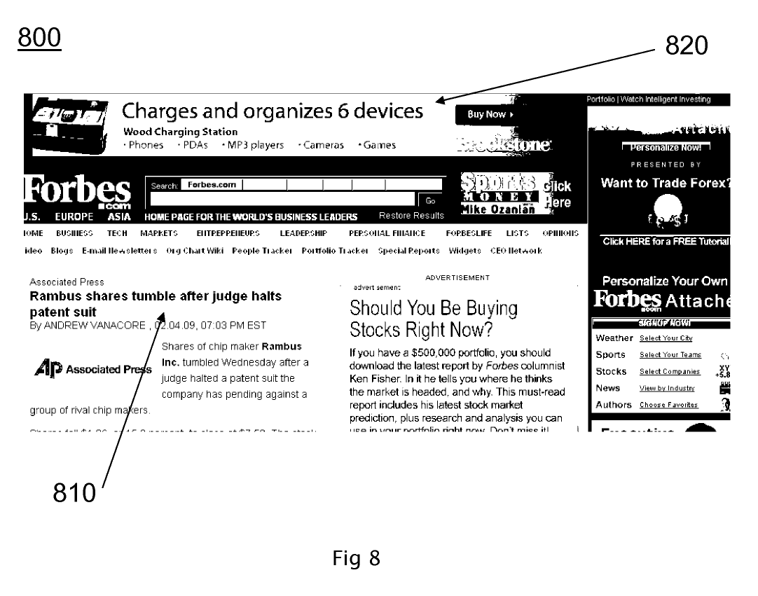

FIG. 8 illustrates a news hole 810 supported by annular messages 820 on a webpage 800.

In an embodiment of the invention, an apparatus comprises:
a circuit for distinguishing links to content provider intellectual property stored in content provider's website servers from links to content sponsor messages at content sponsor message aggregator servers;
a circuit for replacing links to content sponsor messages with links to locally stored messages, wherein messages may be text, graphics, audio, video, programs, or combinations thereof;
a circuit for reporting impressions of localized messages to content providers and content sponsors;
a circuit for reporting http requests initiated by click-throughs on localized messages to content providers and content sponsors; and
a circuit for serving localized messages in conjunction with content provider's intellectual property for display on user browser apparatus through a local area network.

An embodiment of the invention is a method for operating an apparatus for optimizing bandwidth consumption by locally serving annular messages to a user browser apparatus, the apparatus comprising:
an annular server circuit, the annular server circuit coupled to a user browser apparatus and coupled to a wide area network;
a localized message store, the localized message store coupled to the annular server circuit and coupled through a wide area network to a message update center apparatus,
wherein the annular server circuit comprises a circuit for to send a request to a content provider website server, a circuit for to receive a reply from a content provider website server, a circuit for to modify the webpage sent in reply to the request and send the modified webpage to the user browser apparatus.

The method for operating the above apparatus comprises the processes of
analyzing a reply from a content provider to a requesting user to distinguish a link to an annular message hosted on the Internet from links to the content provider's intellectual property,
replacing said links to an annular message hosted on the Internet with a link to an annular message hosted on the local area net, and
transmitting a so-modified reply to the requesting user.

The disclosed invention is a method for operating an apparatus, the apparatus comprising:
a local message store coupled to a local area network,
the local area network coupled to an annular server,
the annular server coupled to a user browser apparatus through the local area network.
the annular server also coupled to a wide area network whereby the annular server proxies requests from the user browser apparatus to servers on the wide area network,
   the method comprising the processes following:
receiving an http request from a user browser apparatus,
proxying the http request to a website external to the local area network,
receiving a webpage from the website in response to the http request,
distinguishing between a content provider's intellectual property and links to a content sponsor message aggregator's message server external to the local area network,
modifying a webpage by replacing links to a content sponsor message aggregator's message server external to the local area network with links to a local message server, and
transmitting the modified webpage to the user browser apparatus.

The method of the invention further includes the processes of receiving and storing in a local server, localized wallpaper and localized messages for transmission to user browser apparatus on a local area network.

The method of the invention further includes the processes of receiving administrative control settings for displaying localized wallpaper and localized messages and
selecting among links to localized wallpaper files and localized message files stored on a localized wallpaper server and a localized message server.

The method of the invention further includes the processes of receiving at a message update center localized messages and
receiving at a message update center settings to control the display of localized messages in selected local area networks.

The method of the invention further includes transmitting from a message update center to a selected annular message server selected messages for storage in the local message store wherein the settings to control the display of localized messages in selected local area networks determine which localized messages are transmitted to which annular servers.

The annular server of the present invention comprises
a conventional proxy circuit, and
a circuit for to receive a reply from an external website server,
a circuit for to find a hypertext markup language reference to an external message server operated by a content sponsor message aggregator,
a circuit for to modify the reply by replacing a hypertext markup language reference to an external message server operated by a content sponsor message aggregator with a hypertext markup language reference to a local message server, and
a circuit to transmit the modified reply to a user browser apparatus for display.

The annular server further includes,
a circuit for to select from a plurality of localized messages and localized wallpaper,
a circuit for to receive an administrative control setting for selection, and
a circuit to receive local wallpaper.

The apparatus of the invention further comprises a message update center apparatus coupled to the annular server and to the localized message store, the message update center apparatus comprising a circuit to receive and to store localized messages.

The message update center apparatus further includes
a circuit for to receive a content sponsor preference setting on where a message should be displayed,
a circuit for to determine which localized message should be stored on which localized message server, and
a circuit to transmit a selected localized message to a specific annular server for storage and for display on a user browser apparatus coupled to the specific annular server.

In the present invention, an http request comprises a TCP/IP packet comprising a hypertext transfer protocol formatted request for a certain webpage and a webpage comprises a text file comprising hypertext markup language tags comprising a text string delimited by href tags.

In an embodiment of the claimed apparatus a circuit comprises a processor adapted by a software program to execute instructions as follows:
to receive a webpage;
to find text delimited by an href tag;
to select a localized message;
to replace text delimited by an href tag with a link to the localized message; and
to transmit the modified webpage to a browser apparatus.

In an embodiment the localized message comprises a blank area whereby bandwidth and attention is conserved.

In an embodiment the localized message comprises an emergency message whereby safety and security is enhanced.

In an embodiment the localized message comprises a beverage or food suggestion appropriate to the user location.

In an embodiment the localized message comprises a schedule of school, sports, or entertainment activities.

In an embodiment the localized message comprises a weather forecast, a stockprice, or an accumulated value.

In an embodiment the localized message comprises a corporate message from the apparatus owner or operator.

### Conclusion

It may be appreciated that the present invention is distinguished from conventional servers and filters by particularly pointing out that it substantially reduces network traffic carrying annular messages and that it improves the utility of annular messages by tailoring the messaging to the demographics or location of the local network specific to each annular server apparatus. It is understood that a processor adapted to implement the steps of the process is an embodiment of the invention. It is understood that in an embodiment of the invention, a circuit disclosed in the present application is a processor as disclosed in FIG. 1 controlled by software. It is understood that a cellular base station supporting mobile browsers is an embodiment of a local network. It is understood that in an embodiment, a user browser apparatus includes a cellular telephone having a processor controlled by browser application software and localized messages may be selected to a specific cell of a cellular network.

Significantly, this invention can be embodied in other specific forms without departing from the spirit or essential attributes thereof, and accordingly, reference should be had to the following claims, rather than to the foregoing specification, as indicating the scope of the invention.

What is claimed is:

1. An apparatus comprising
a circuit for to distinguish links to content provider intellectual property from links to content sponsor messages;
a circuit for to replace links to content sponsor messages with links to locally stored annular wallpaper or messages;
a circuit for to report impressions of cached annular messages to content providers and to content sponsors;
a circuit for to report http requests made by click-throughs on localized messages to content providers and content sponsors; and
a circuit for to serve localized messages in conjunction with a content provider's intellectual property to a user browser apparatus.

2. A method for operating an apparatus for optimizing bandwidth consumption by serving annular messages to a browser, the apparatus comprising:
an annular server circuit, the annular server circuit coupled to a user browser apparatus and coupled to a wide area network;
a localized message store, the localized message store coupled to the annular server circuit,
wherein the annular server circuit comprises a circuit for to send a request to a content provider, a circuit for to receive a reply from a content provider, a circuit for to modify the webpage and send the modified webpage to the user browser apparatus,
the method comprising the processes of analyzing a reply from a content provider to a requesting user to distinguish a link to an annular message hosted on the Internet from links to the content provider's intellectual property, replacing said links to an annular message hosted on the Internet with a link to an annular message hosted on the local area network, and transmitting a so-modified reply to the requesting user.

3. The apparatus of claim 2 wherein a local area network comprises a cellular base station coupled to a mobile browser apparatus through wireless network apparatus.

4. A method for operating an apparatus
comprising a local message store coupled to a local area network,
the local area network coupled to an annular server,
the annular server coupled to a user browser apparatus through the local area network.
the annular server also coupled to a wide area network whereby the annular server proxies requests from the user browser apparatus to servers on the wide area network,
the method comprising the processes following:
receiving an http request from a user browser apparatus,
proxying the http request to a website external to the local area network,
receiving a webpage from the website in response to the http request,
distinguishing between a content provider's intellectual property and links to a content sponsor message aggregator's message server external to the local area network,
modifying a webpage by replacing links to a content sponsor message aggregator's message server external to the local area network with links to a local message server, and
transmitting the modified webpage to the user browser apparatus.

5. The method of claim 4 further comprising the processes of receiving and storing in a local server, localized wallpaper and localized messages for transmission to user browser apparatus on a local area network.

6. The method of claim 4 further comprising the processes of receiving administrative control settings for displaying localized wallpaper and localized messages and selecting among links to localized wallpaper files and localized message files stored on a localized wallpaper server and a localized message server.

7. The method of claim 4 further comprising the processes of receiving at a message update center localized messages and receiving at a message update center settings to control the display of localized messages in selected local area networks.

8. The method of claim 7 further comprising transmitting from a message update center to a selected annular message server selected messages for storage in the local message store wherein the settings to control the display of localized messages in selected local area networks determine which localized messages are transmitted to which annular servers.

9. The apparatus of claim 4 wherein the annular server comprises
a conventional proxy circuit, and
a circuit for to receive a reply from an external website server,
a circuit for to find a hypertext markup language reference to an external message server operated by a content sponsor message aggregator,
a circuit for to modify the reply by replacing a hypertext markup language reference to an external message server operated by a content sponsor message aggregator with a hypertext markup language reference to a local message server, and
a circuit to transmit the modified reply to a user browser apparatus for display.

10. The apparatus of claim 4 further comprising,
a circuit for to select from a plurality of localized messages and localized wallpaper,
a circuit for to receive an administrative control setting for selection, and
a circuit to receive local wallpaper.

11. The apparatus of claim 4 further comprising a message update center apparatus coupled to the annular server and to the localized message store, the message update center apparatus comprising a circuit to receive and to store localized messages.

12. The apparatus of claim 11 further comprising a circuit receive a content sponsor preference setting on where a message should be displayed and a circuit for to determine which localized message should be stored on which localized message server, and a circuit to transmit a selected localized message to a specific annular server for storage and for display on a user browser apparatus coupled to the specific annular server.

13. The method of claim 4 wherein an http request comprises a TCP/IP packet comprising a hypertext transfer protocol formatted request for a certain webpage and a webpage comprises a text file comprising hypertext markup language tags comprising a text string delimited by href tags.

14. The apparatus of claim 10 wherein a circuit comprises a processor adapted by a software program to execute instructions as follows:
to receive a webpage;
to find text delimited by an href tag;
to select a localized message;
to replace text delimited by an href tag with a link to the localized message; and
to transmit the modified webpage to a browser apparatus.

15. The apparatus of claim 14 wherein said localized message comprises a blank area whereby bandwidth and attention is conserved.

16. The apparatus of claim 14 wherein said localized message comprises an emergency message whereby safety and security is enhanced.

17. The apparatus of claim 14 wherein said localized message comprises a beverage or food suggestion appropriate to the user location.

18. The apparatus of claim 14 wherein said localized message comprises a schedule of school, sports, or entertainment activities.

19. The apparatus of claim 14 wherein said localized message comprises a weather forecast, a stock price, or an accumulated value.

20. The apparatus of claim 14 wherein said localized message comprises a corporate message from the apparatus owner or operator.
